(19) United States
(12) Patent Application Publication
(10) Pub. No.: US 2011/0013014 A1
(43) Pub. Date: Jan. 20, 2011

(54) METHODS AND ARRANGEMENTS FOR ASCERTAINING A TARGET POSITION

(75) Inventor: Tomas WASSINGSBO, Malmo (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communication AB, Lund (SE)

(21) Appl. No.: 12/505,060

(22) Filed: Jul. 17, 2009

(51) Int. Cl. H04N 7/18; G01C 21/00; G06F 3/041; G06F 3/00

(52) U.S. Cl. 348/113; 701/208; 701/209; 345/173; 715/700; 348/E07.085

(57) ABSTRACT

A method of determining a target geographic location, using an electronic device including a global positioning system (GPS) receiver, a digital camera, and a display for presenting images and functioning as a viewfinder for the digital camera, is provided. The method includes creating, by one or more components of the electronic device, an image of a physical map; comparing, by the one or more components, at least a portion of the image of the physical map with map data stored in a database associated with the electronic device; identifying, based on the comparing, particular map data that substantially corresponds to the map picture; indicating, by a user of the electronic device, a position on the physical map, the image of the physical map as presented via the display, or the identified map data as presented via the display; and corresponding the indicated position to a particular location in the identified map data, the particular location being information usable by the GPS receiver as the target geographic location.

### TECHNICAL FIELD

The present invention relates to a method of ascertaining a target position in an electronic device comprising a GPS receiver and a wireless electronic device adapted to present a suggested target position.

### BACKGROUND OF THE INVENTION

Navigation using a Global Positioning System receiver (GPS receiver) and electronic maps is commonly practised. However, the physical map, “paper map,” is still frequently used and will continue to be used in parallel with GPS-devices (devices comprising GPS receiver).

For instance, a tourist often receives a paper map indicating various points of interest, such as different tourist attractions. Another example is when someone would like to show a point of interest to a person, such as the location of a restaurant. The location is easily pointed out on a “paper map” or a “public information map”, e.g. located in connection with public transportations.

There exists a general problem when an identified point of interest on a physical map is to be entered into a GPS-device.

Modern GPS-devices often require entry of an address of a target position, preferably a street name and number or an intersection between two streets. In some physical maps street numbers may not be marked out and physical maps may not contain names of all streets. Many places do not have a street name, e.g. in a nautical chart or a map of fields and forests.

It is therefore difficult to use modern GPS-devices to be guided to a target position if no address is available. Even if an address is available, it is often cumbersome to enter the address into a GPS-device, or relevant coordinates in case of locations in thinly populated areas and/or rural areas.

### SUMMARY

Embodiments of the present invention may facilitate input of a target position into a GPS-enabled device.

According to an aspect of the invention, a method of ascertaining a target position in an electronic device may include a GPS receiver, a digital camera and a display for presenting taken pictures and acting as a viewfinder for the digital camera. The method may include the steps of:

creating using the digital camera, or in an image sensor of the digital camera, a map picture of a physical map,

comparing at least a portion of the map picture with maps stored in a database to identify and match the map picture with an actual map stored in the database,

indicating a first position on the physical map or on the map picture as presented on the display or on the actual map as presented on the display, and

matching the first position with an actual position utilizing the actual map, the actual position being in a format to be utilized by the GPS receiver as the said target position.

It is to be understood that a GPS receiver is a device or part of a device utilizing received messages sent from GPS satellites to establish a present position of the GPS receiver. Further, it is to be understood that a GPS receiver has the capability of utilizing a map or a set of maps to direct a user from a present position to a target position. The map or set of maps utilized by the GPS receiver may be in the same format as the maps stored in the database. Alternatively, they may be in a different format. A digital camera has the capability to take and store pictures as they are projected on the image sensor of the digital camera. A target position may be used immediately by the electronic device or saved for future use in the electronic device.

Since a physical map is utilized to indicate an actual position to the electronic device comprising a GPS receiver as a target position, a user friendly method of inputting a target position is provided. As a result, the above mentioned object is achieved.

The electronic device may for instance be a mobile communication device such as a mobile phone. It may alternatively be a GPS-device, a digital camera or other wireless electronic device. It is foreseen that the electronic device may handle maps in one or more digital formats. The map picture created may be a picture taken and stored by the digital camera in an ordinary manner, but may alternatively be an image registered by the image sensor. The various steps of the method may be performed in a different order than indicated above. For instance, the comparing step of the map picture with the maps stored in the database may be performed before or after the indicating step.

According to example embodiments the method may further include the steps of:
presenting a suggested target position based on the actual position, and
selecting by a user of the electronic device the suggested target position as a definite target position to be used by the GPS receiver. In this manner a user may select a definite target position.

It may well be that more than one actual position is retrieved as matching the first position. In this case presenting different suggested target positions with relevant information, such as street name and number and/or town of suggested target position, site at suggested target position, may provide a user with sufficient information to select one of the suggest target positions as the definite target position.

According to example embodiments the step of presenting a suggested target position may include taking into consideration a present position of the electronic device. In this manner likely irrelevant suggested target positions may be excluded or given a lower rank (e.g. a lower position in a list of suggested target positions). The electronic device may be preset to present suggested target positions based on how close they are to the present position of the electronic device.

According to example embodiments the method may further comprising the step of:
transferring the actual map, or data corresponding to at least a part of the actual map from the database to the GPS receiver for the purpose of indicating at least the actual position to the GPS receiver. This may entail a spectrum of different possibilities. At one end of the spectrum there is returned from the database the actual position in a format suitable for input to the GPS receiver, and at the other end of the spectrum the electronic device is capable of handling an actual map in a format received from the database and there from extract the actual position in a format suitable for input to the GPS receiver.

According to example embodiments the step of indicating a first position may include pointing with a pointer on the first position. This may be done in a number of different ways or a combination of these different ways.

According to example embodiments the method may comprise the steps of:
pointing on the physical map at the first position using a physical pointer such that the map picture includes the physical pointer,
identifying the physical pointer in the map picture,
finding an end of the physical pointer in the map picture, and
identifying a position on the physical map at the end of the physical pointer as the first position. In this manner a user may point with a finger, pen or other suitable physical pointer at a point of interest on the map picture. Optionally, the further steps may be comprised:
creating a picture of the same physical map without the physical pointer present, and
comparing the map picture with the physical pointer with the map picture without the physical pointer to aid in the step of finding the end of the physical pointer. Electronically overlapping the two pictures, which are identical except for the presence of the physical pointer in one picture, may aid a process designed to identify the physical pointer and an end thereof in a picture.

According to example embodiments the method may comprise the steps of:
pointing on the map picture as presented on the display or the actual map as presented on the display using a physical pointer on the display, the display being a touch screen, and
identifying the first position as a position of the physical pointer on the map picture or on the actual map. Accordingly, a user may use e.g. his finger to point on the touch screen at the map picture or the actual map to indicate the first position. Whether the map picture or actual picture is presented on the display may depend on whether the said step of comparing at least a portion of the map picture has yet been performed or not.

According to example embodiments the method may comprise the steps of:
pointing on the map picture as presented on the display or the actual map as presented on the display using a digital pointer on the display, and
identifying the first position as a position of the digital pointer in the map picture or on the actual map. Again, whether the map picture or actual picture is presented on the display may depend on whether the said step of comparing at least a portion of the map picture has yet been performed or not.

According to example embodiments the steps of the method may be automatically started when a pattern is identified as a map structure of a physical map by the electronic device, on a taken picture or on the image sensor. In this manner the electronic device is primed to perform the method when a user aim the camera at a physical map or takes a picture of the physical map. Alternatively, the method may be automatically started, when in addition to the map structure, a physical pointer is identified on the taken picture or on the image sensor.

According to example embodiments the steps of the method may be started when a camera trigger of the electronic device is activated. In this manner a user may decide when to start the method, e.g. when he or she is pointing with a finger at a point of interest on a physical map and taking a map picture pushing the camera trigger.

According to example embodiments the steps of the method may be started by a user after the map picture has been taken using the digital camera. In this manner a user may first take a map picture and store it in the electronic device and thereafter, e.g. at a later occasion, indicate a point of interest.

According to example embodiments the method may comprise the step of:
indicating a second position on the physical map or on the map picture as presented on the display or on the actual map as presented on the display. In this manner a user may indicate two points of interest on a map to eventually create two target positions in the electronic device, e.g. for the purpose of being directed by the GPS receiver to both target positions.

According to example embodiments the method may comprise the steps of:
indicating at least one further position on the physical map or on the map picture as presented on the display or on the actual map as presented on the display,
forming a route by the GPS receiver utilizing the first position, the second position and the at least one further position, and
presenting the route to a user of the electronic device.

According to example embodiments the method may comprise the step of:
identifying text and/or objects on the physical map to aid in the step of comparing at least a portion of the map picture. The identified text or an identified object may be utilized to find the actual map in the database. This may be performed both quicker and more accurately than if no text or no object is utilized.

According to example embodiments the database may be stored in the electronic device. This may be a database separate from the GPS receiver or a database common with the GPS receiver. As an alternative, the database may be stored on a server separate from the electronic device, and the method may include the step of:
transferring data between in the electronic device and the server. Such data may for instance be the map picture, a portion of the map picture, the actual map, a portion of the actual map or the actual position. The data may include the first position. It is thus foreseen that the step of comparing at least a portion of the map picture may be performed in the electronic device or externally from the electronic device, e.g. on the server. Also the step of matching the first position with an actual position may be performed in the electronic device or externally from the electronic device, e.g. on the server.

According to an aspect of the invention there is provided a wireless electronic device adapted to present a suggested target position and comprising,
a digital camera comprising an image sensor and configured to take a map picture of a physical map and to sense a corresponding map picture on the image sensor,
a processor configured to compare at least a portion of the map picture with maps stored in a database to identify and match the map picture with an actual map stored in the database or configured to receive at least a part of an actual map corresponding to at least a part of the map picture,
a display adapted to present taken pictures and acting as a viewfinder for the digital camera, and
a GPS receiver, wherein
   the processor further is configured to
identify a first position on the physical map or on the map picture as presented on the display or on the actual map as presented on the display, and to
match the first position with an actual position by utilizing the actual map or to receive an actual position based on the first position from the database, the actual position being in a format to be utilized by the GPS receiver as a target position, and to
present the actual position as the suggested target position to be used by the GPS receiver.

The processor may be a separate processor in the electronic device or it may be a processor of the GPS receiver or a processor of the digital camera. It is also foreseeable that the processor in practice may comprise several separate portions, each portion adapted for specific data processing.

According to example embodiments the display may be configured to present an image in several layers and one layer may be adapted to comprise the map picture and one layer may be adapted to comprise the actual map.

According to example embodiments the display may be configured to present in a further layer the first position.

According to example embodiments a user interface may incorporate the display for output of visual information from the GPS receiver.

According to example embodiments the digital camera may have the capability of being utilized as a video camera taking consecutive pictures and the display may be a touch screen configured to show the consecutive pictures and to receive input from a user pointing on at least two different positions on the display, and wherein the processor is configured to identify the first position as one of the at least two different positions and a second position as a second of the at least two different positions in two corresponding map pictures out of the consecutive pictures. In this manner a user may video film a physical map and point out different points of interest. In example embodiments the touch screen and the processor may be configured to create each of the two corresponding map pictures upon a user touching the touch screen. In this manner the electronic device may identify when the touch screen is touched and thus a corresponding map picture contains the first and the second positions, respectively.

Further features of, and advantages with, the present invention will become apparent when studying the appended claims and the following description. Those skilled in the art will realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 illustrates schematically a wireless electronic device according to exemplary embodiments;

FIG. 2 illustrates a method of ascertaining a target position in an electronic device according to exemplary embodiments;

FIG. 3 illustrates additional further steps of a method according to exemplary embodiments;

FIG. 4 illustrates an additional step of a method according to exemplary embodiments;

FIG. 5 illustrates a method of ascertaining a target position in an electronic device according to exemplary embodiments;

FIGS. 6, 8, 9, and 12 illustrate method steps according to exemplary embodiments;

FIG. 7 illustrates schematically how an end of a physical pointer in the form of a finger indicates a first position on a physical map;

FIG. 10 illustrates exemplary initiating of a method of ascertaining a target position in an electronic device;

FIG. 11 illustrates a method according to exemplary embodiments in which further points of interest are entered; and

FIG. 13 illustrates schematically exemplary display layering.

### DETAILED DESCRIPTION

The present invention will now be described more fully with reference to the accompanying drawings, in which example embodiments are shown. However, the invention should not be construed as limited to the embodiments set forth herein. Disclosed features of example embodiments may be combined as readily understood by one of ordinary skill in the art to which this invention belongs. Like numbers may refer to like elements throughout.

As used herein, the terms, “including,” “includes,” “comprising,” “comprises,” and/or variants thereof are open-ended, and includes one or more stated features, elements, steps, components, and/or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e. ”, which derives from the Latin phrase “id est,” may be used to specify a particular item from a more general recitation.

The terminology used herein is for the purpose of describing particular embodiments only and is not intended to be limiting of the invention. As used herein, the singular forms, “a”, “an” and “the,” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

Well-known functions or constructions may not be described in detail for brevity and/or clarity.

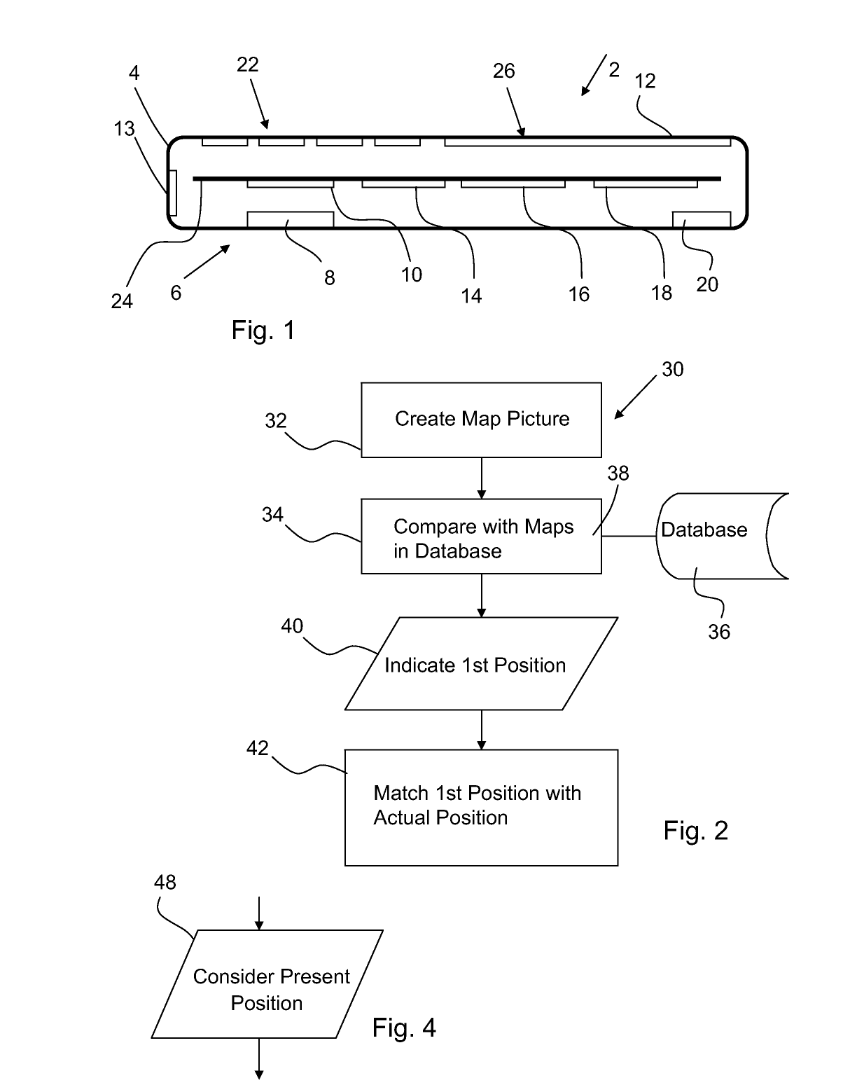

FIG. 1 illustrates schematically a wireless electronic device 2 according to example embodiments. Wireless electronic device 2 exemplified is a mobile phone 4, of which a section is illustrated. Mobile phone 4 may include a camera arrangement, digital camera 6, which may include a lens 8 and an image sensor 10. Digital camera 6 may be configured to take pictures. A display 12 of mobile phone 4 may be used as a viewfinder when a user directs digital camera 6 at a suitable subject of which to take a picture. Display 12 may present pictures. The user may activate a camera trigger 13 to take a picture. Captured pictures may be stored in a memory 14 of mobile phone 4. Mobile phone 4 may further include a processor 16, a GPS receiver 18, an antenna 20, and/or a keypad 22. According to example embodiments, various components of mobile phone 4 may be arranged on a printed circuit board (PCB) 24. In FIG. 1, image sensor 10 of digital camera 6, memory 14, processor 16, and GPS receiver 18 are illustrated mounted on PCB 24. Of course, mobile phone 4 may include a speaker and/or microphone (not shown).

According to example embodiments, display 12 may be a touch screen 26, which may be used to provide input to mobile phone 4. In this case, keypad 22 may still be present on mobile phone 4, it may contain a reduced number of keys and/or it may be omitted.

According to example embodiments, memory 14 may be used for storing other data and/or additional data besides taken pictures, e.g., a database of maps. Memory 14 may store data to be used in various processes performed in electronic device 2, e.g., data to be used by GPS receiver 18. Processor 16 may be integrated with other processing devices, such as GPS receiver 18, and/or processor 16 may include one or more devices, several corresponding components, each adapted to perform specific tasks in electronic device 2. Processor 16, the other processing device, or at least one of the corresponding components, may be configured to compare data files, e.g., a captured picture with a stored picture. Alternatively, processor 16, the other processing device, or at least one of the corresponding components, may be configured to receive data for further use in electronic device 2.

FIG. 2 illustrates a method 30 of ascertaining a target geographic position in an electronic device, according to example embodiments. Method 30 may be performed in wireless electronic device 2 illustrated in FIG. 1, and may be adapted to facilitate input of a point of interest on a physical map, e.g., a city map, as a target geographic position in electronic device 2.

Method 30 may include:

Creating a map picture of a physical map (step 32). The map picture is either created using digital camera 6 and may be stored in memory 14 or it is created in the image sensor 10 of digital camera 6. In the latter case the created map picture is not stored in memory 14 as a taken picture but exists as a momentary created map picture to be further processed in accordance with method 30. The map picture in the latter case as created in image sensor 10 may be presented on display 12 acting as a viewfinder for digital camera 6.

Comparing at least a portion of the created map picture with maps stored in a database 36 (step 34). Purposes of comparing step 34 include identifying and matching the map picture with an actual map stored in database 36. Database 36 may be stored in memory 14 of electronic device 2, and the maps may be the same maps as used by GPS receiver 18. In a second alternative the database 36 may be stored on a server separate from the electronic device 2. According to the first alternative, processor 16 may perform the comparing step 34 and data is transferred 38 between processor 16 and database 36 within electronic device 36. According to the second alternative, transferring 38 data between electronic device 2 and the server may be performed wirelessly. Data returned from the server to electronic device 2 may be the actual map of interest, several actual maps of interest if not one single actual map could be identified, a limited portion of one or more actual maps, or one or more positions or coordinates from one or more actual maps. Depending on the returned data from the server, processor 16 may compare the data further with the map picture or receive data for further use in electronic device 2, e.g., in GPS receiver 18. Image analysis of the map picture or pattern recognition of, for example, street intersections in the map picture may be utilized to match the map picture with an actual map.

Indicating a first position on the physical map or on the map picture as presented on display 12 or on the actual map as presented on display 12 (step 40).

Matching the first position with an actual position utilizing the actual map (step 42). The actual position is in a format to be utilized by GPS receiver 18 as the target position. Matching step 12 may be performed by processor 16 to extract the actual position. Alternatively, if the first position is in a format to be utilized by GPS receiver 18 the GPS receiver may perform matching step 42. It is also foreseen that matching step 42 alternatively may be performed on the separate server, in which case the actual position is transferred from the server to processor 16 or GPS receiver 18 of electronic device 2.

The indicating step 40 may be performed before or after comparing step 34. If the first position is indicated on the physical map indicating step 40 must be performed before comparing step 34. If the first position is indicated on the map picture the indicating step 40 may be performed before or after the comparing step 34. If the first position is indicated on the actual map the indicating step 40 must be performed after the comparing step 34. The geographic target position may be stored for future use in the electronic device 2 or the GPS receiver 18 thereof. Alternatively, the target geographic position may be utilized immediately in the GPS receiver 18 such that the electronic device 2 may at once direct a user from a present position to the target geographic position.

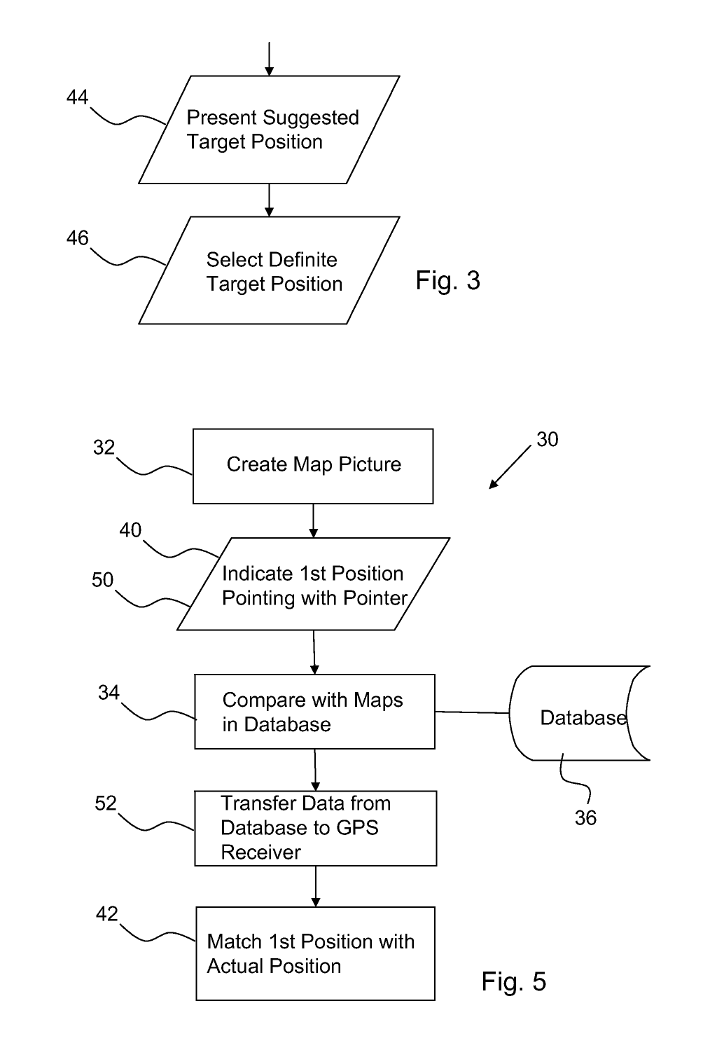

FIG. 3 illustrates additional further steps of a method according to example embodiments:

Presenting a suggested target geographic position based on the actual position (step 44). A user is thus able to appreciate the suggested target position, e.g., as presented via display 12.

Confirming, by a user of electronic device 2, the suggested target geographic location as a definite target geographic position to be used by the GPS receiver 18 (step 46). The user may in this manner decide whether the suggested target geographic location corresponds to the point of interest he has previously found on the physical map.

Electronic device 2 may present several suggested target positions, out of which the user may select the one that corresponds to a desired point of interest.

FIG. 4 illustrates an additional method step according to some embodiments. A present position of the electronic device may be taken into consideration 48 when ascertaining the target position. This may be done at one or more out of several steps of the method, for instance in comparing step 34, when the map picture is compared with maps of the vicinity of the present position before it is compared with maps further away from the present position and/or in matching step 42 and/or in presenting step 44. In some practical situations, it is namely foreseen that a user is fairly close to a point of interest, which the user would like to select as a target position in electronic device 2, e.g., when a tourist in a city has been provided with a tourist map and on the tourist map a point of interest, such as a restaurant, has been marked out.

The current geographic location of electronic device 2 may be based on the cell id of a base station, with which electronic device 2 at present is in contact with. A more precise current geographic location may be provided by GPS receiver 18 of electronic device 2, establishing its position. Electronic device 2 may receive information about relevant GPS satellite frequencies from a base station to speed up establishing of the present position using GPS receiver 18, so-called assisted GPS.

FIG. 5 illustrates a method 30 of determining a target geographic location in an electronic device according to example embodiments. Method 30 may be performed in wireless electronic device 2 illustrated in FIG. 1 and may be adapted to facilitate input of a point of interest on a physical map, e.g., a city map, as a target position in electronic device 2. Some method steps illustrated in FIG. 5 are similar to the method steps illustrated in FIG. 2 and for a detailed description of these method steps it is referred to the description relating to FIG. 2. For illustrating purposes some steps have been illustrated in a different order in FIG. 5 than in FIG. 2. However, the skilled person understands that method step order and steps illustrated in FIGS. 2 and 5 and corresponding description portions may be applied in same example embodiments.

Method 30 may comprise the steps of:

Creating a map picture of a physical map (step 32).

Indicating a first position by pointing 50 with a pointer on the first position (step 40).

Comparing at least a portion of the created map picture with maps stored in a database 36 to identify and match the map picture with an actual map stored in database 36 (step 34).

Matching the first position with an actual position utilizing the actual map. The actual position is in a format to be utilized by GPS receiver 18 as the target position (step 42).

Transferring the actual map, or data corresponding to at least a part of the actual map, from database 36 to GPS receiver 18 for the purpose of indicating at least the actual position to GPS receiver 18 precedes matching step 42 (step 52). In this manner, GPS receiver 18 is provided with actual map data.

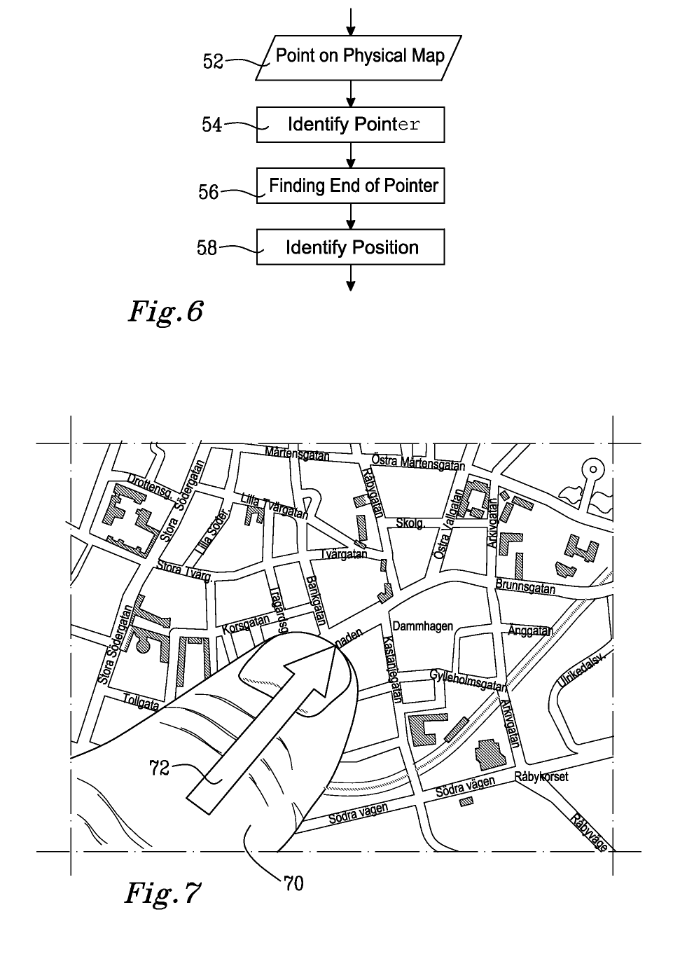

Again, indicating step 40 may be performed before and/or after comparing step 34, inter alia, as further described below in example embodiments of methods as illustrated in FIGS. 6, 8, and 9.

FIG. 6 illustrates a method according to example embodiments in which indicating step 40 and pointing step 50 may be performed using a physical pointer such as a finger on the physical map. Accordingly, the method may include:

Pointing on the physical map at the first position using a physical pointer such that the map picture includes the physical pointer (step 52). This step is thus performed before comparing step 34 and also before creating step 32.

Identifying the physical pointer in the map picture (step 54). This may be done for instance using colour analysis, comparison with stored images of different physical pointers such as a finger, a pen or an ink mark, or comparison of contrasting shapes in the map picture.

Finding an end of the physical pointer in the map picture (step 56).

Identifying a position on the physical map at the end of the physical pointer as the first position (step 58).

Identifying step 54, finding step 56, and/or identifying step 58 may be performed before, during, and/or after comparing step 34.

FIG. 7 illustrates schematically how an end of a physical pointer in the form of a finger 70 indicates a first position on a physical map. An application, suitably executed in processor 16, of electronic device 2, using a finger detection algorithm to find a narrow edge end point of the finger indicated by an arrow 72. At this end point, the first position is identified on the physical map.

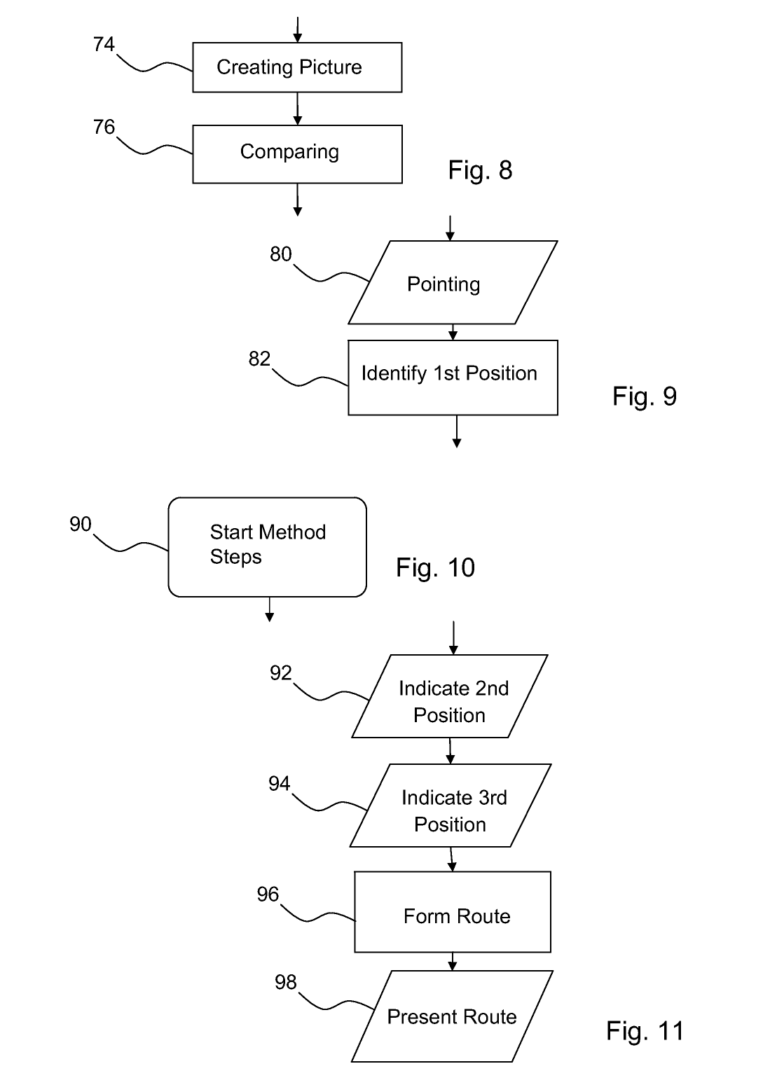

FIG. 8 illustrates optional steps to be inserted before identifying step 54 illustrated and described in connection with FIG. 6 to provide a further way of identifying a physical pointer in a map picture, which may include:

Creating a picture of the same physical map without the physical pointer present (step 74). That is, before or after creating the map picture with the physical pointer present, an essentially identical picture is taken where no physical pointer is present.

Comparing the map picture with the physical pointer with the map picture wherein the physical pointer is not present (step 76). By identifying a portion which differs in the two map pictures, the physical pointer may be identified and thus the step of finding the end of the physical pointer is facilitated.

FIG. 9 illustrates a method according to example embodiments in which indicating step 40 and pointing step 50 are performed using display 12 in the form of a touch screen 26. Accordingly, the method may include:

Pointing on the map picture as presented on touch screen 26 and/or on the actual map as presented on touch screen 26, using a physical pointer on touch screen 26 (step 80).

Identifying the first position as a position of the physical pointer on the map picture or on the actual map (step 82).

A user may thus indicate on touch screen 26, using a finger or a dedicated pointing device, where the first position is. In case the first position is indicated on the map picture, this may be done after creating map picture step 32 has been performed before or after comparing step 34. In case the first position is indicated on the actual map this may be done after comparing step 34 when an actual map has been identified in database 36.

FIG. 9 is also used to illustrate a method according to example embodiments in which indicating step 40 and pointing step 50 are performed using display 12 and a digital pointer, such as a cursor which may be moved in display 12 using keypad 22. Accordingly, the method may include:

Pointing on the map picture as presented on display 12 or on the actual map as presented on display 12 using a digital pointer on display 12 (step 80).

Identifying the first position as a position of the digital pointer in the map picture or on the actual map (step 82).

A user may thus indicate on display 12 using a cursor where the first position is, for instance by positioning the cursor over a point of interest on the map picture or the actual map and then confirming the first position by pressing an “Enter” key on keypad 22. In case the first position is indicated on the map picture this may be done after creating map picture step 34 has been performed, before or after comparing step 34. In case the first position is indicated on the actual map this may be done after comparing step 34 when an actual map has been identified in database 36.

FIG. 10 illustrates how a method of ascertaining a target position in an electronic device according to example embodiments may be initiated. Accordingly, the steps of the method may be started 90 automatically when a pattern is identified as a map structure of a physical map by electronic device 2, on a taken picture or on image sensor 10. Additionally, the steps of the method may be automatically started 90, when in addition to the map structure, a physical pointer (e.g., a stylus) is identified on the taken picture or on image sensor 10.

According to example embodiments the steps of the method may be started 90 when a camera trigger of said electronic device is activated, i.e., when the creating map picture step 32 is performed by a user pushing the camera trigger. A further alternative may be that the steps of the method are started 90 by a user when the said map picture has been taken by the digital camera, e.g., when creating map picture step 32 has been previously performed by a user and the taken picture has been stored in memory 14 and the stored map picture is recalled for performing any of the proceeding steps of the method.

FIG. 11 illustrates a method according to example embodiments in which further points of interest are entered into electronic device 2, e.g., for the purpose of providing GPS receiver 18 of electronic device 2 with further target positions and/or for laying out a route to be entered into GPS receiver 18. Accordingly, the method may include:

Indicating a second position on the physical map or on the map picture as presented on display 12 or on the actual map as presented on display 12 (step 92). The second position may be processed according to relevant steps of methods according to example embodiments to ascertain a second target position.

The method may further include:

Indicating at least a third position on the physical map and/or on the map picture as presented on display 12 or on the actual map as presented on display 12 (step 94).

Forming a route by GPS receiver 18 utilizing the first position, the second position and the third position (step 96).

Presenting the route to a user of electronic device 12, e.g., by rendering the route on display 12 and/or outputting audible instructions (step 98).

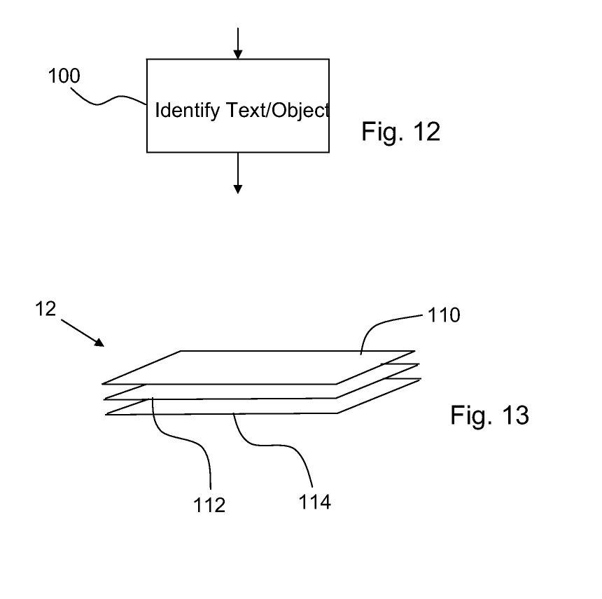

FIG. 12 illustrates that a method of ascertaining a target position in an electronic device 2 according to example embodiments may include:

Identifying text and/or objects, such as monuments or other features, on the physical map to aid in comparing step 34 at least a portion of said map picture (step 100). By using for instance optical character recognition (OCR) scanning to interpret street names, place names, landmarks, and/or sites on the map picture when comparing the map picture with maps stored in the database, identifying a corresponding actual map may be greatly facilitated.

FIG. 13 schematically illustrates display 12 of electronic device 2, which is configured to present an image in several layers. A first layer 110 is adapted to present the map picture and a second layer 112 is adapted to present the actual map. Display 12 may be configured to present in a further layer 114, the first position. For example, layers 110, 112, and 114 may be superimposed, such that at least portions of each may be concurrently visible to the user.

An operating system of electronic device 2 may include a menu, which may be presented on display 12. The menu may include different commands, which a user may select to provide input when methods according to example embodiments are performed.

Example embodiments may be combined as understood by a person skilled in the art. It is also understood by those skilled in the art that input from a user may be provided to facilitate comparing step 34, e.g., by entering a city name or a location illustrated on the physical map. The physical map may be a nautical chart or a map of a part of nature with street names. In this case for instance landmarks, elevation curves or island may be used in comparing step 34 to identify a corresponding actual map. In some cases a hand drawn map may suffice as a physical map to create the map picture from (step 32).

Therefore, it is to be understood that the foregoing is illustrative of various example embodiments and is not to be limited to the specific embodiments disclosed and that modifications to the disclosed embodiments, combinations of features of disclosed embodiments as well as other embodiments are intended to be included within the scope of the appended claims.

What is claimed is:

1. A method of determining a target geographic location, using an electronic device including a global positioning system (GPS) receiver, a digital camera, and a display for presenting images and functioning as a viewfinder for the digital camera, the method comprising:
creating, by one or more components of the electronic device, an image of a physical map;
comparing, by the one or more components, at least a portion of the image of the physical map with map data stored in a database associated with the electronic device;
identifying, based on the comparing, particular map data that substantially corresponds to the map picture;
indicating, by a user of the electronic device, a position on the physical map, the image of the physical map as presented via the display, or the identified map data as presented via the display; and
corresponding the indicated position to a particular location in the identified map data, the particular location being information usable by the GPS receiver as the target geographic location.

2. The method of claim 1, further comprising:
presenting to the user, based on the particular location, a suggested geographic location; and
receiving a selection, from the user, the suggested geographic location as the target geographic location to be used by the GPS receiver.

3. The method of claim 2, where presenting the suggested geographic location is based on a current position of the electronic device determined by the GPS receiver.

4. The method of claim 1, further comprising:
retrieving the identified map data from the database; and
transferring the retrieved map data including the indicated position to the GPS receiver.

5. The method of claim 1, where indicating a position on the physical map comprises using a pointer to point to the indicated position.

6. The method of claim 5, where using a pointer comprises:
pointing to the physical map, at the indicated position, using a physical pointer, where the image of the physical map includes at least a partial image of the physical pointer,
identifying the physical pointer in the image of the physical map,
determining an end of the physical pointer in the image of the physical map, and
selecting a position on the physical map at the end of the physical pointer as the indicated position.

7. The method of claim 6, further comprising:
creating another image of the physical map that does not include the at least partial image of the physical pointer, where determining the end of the physical pointer comprises comparing the other image of the physical map to the image of the physical map.

8. The method according to claim 5, further comprising:
pointing to the displayed image of the physical map or the displayed identified map data, where the display comprises a touch screen, and
identifying the indicated position as a position of the physical pointer on the touch screen corresponding to an area of the displayed image of the physical map or the displayed identified map data.

9. The method of claim 5, further comprising:
pointing to the displayed image of the physical map or the displayed identified map data, using a digital pointer on the display, and
identifying the indicated position as a position of the digital pointer in the displayed image of the physical map or the displayed identified map data.

10. The method of claim 1, further comprising:
identifying a pattern in an image, received or captured by the electronic device, as corresponding to map information; and
automatically initiating the determining the target geographic location when the pattern is identified.

11. The method of claim 1, further comprising:
identifying a pattern in an image, received or captured by the electronic device, as corresponding to map information;
identifying a physical pointer in the image, received or captured by the electronic device; and
automatically initiating the determining the target geographic location when the pattern and the physical pointer are identified.

12. The method of claim 1, further comprising:
automatically initiating the determining the target geographic location upon activation of a trigger of the digital camera.

13. The method of claim 1, initiating the determining the target geographic location, responsive to the user capturing the image of the physical map using the digital camera.

14. The method of claim 1, further comprising:
indicating another position on the physical map, the displayed image of the physical map, or the displayed identified map data.

15. The method of claim 14, further comprising:
indicating at least one other position on the physical map, the displayed image of the physical map, or the displayed identified map data;
forming a route, by the GPS receiver using the identified position, the other position, and the at least one other position; and
presenting the route to the user via the display.

16. The method according to claim 1, where the comparing at least a portion of the image of the physical map comprises identifying text and/or particular features on the physical map.

17. The method of claim 1, where the database resides in the electronic device.

18. The method of claim 1, where the database resides on a server remote to the electronic device.

19. A wireless electronic device to present a suggested target geographic location, comprising:
a digital camera including an image sensor and to take a map picture of a physical map and to sense a corresponding map picture on the image sensor;
a processor to compare at least a portion of the map picture with maps stored in a database to identify and match the map picture with an actual map stored in the database or to receive at least a part of an actual map corresponding to at least a part of the map picture;
a display to present taken pictures and operate as a viewfinder for the digital camera, and
a GPS receiver, where the processor is to
identify a first position on the physical map, the map picture as presented on the display, or the actual map as presented on the display,
match the first position with an actual position by utilizing the actual map or to receive an actual position based on the first position from the database, the actual position being in a format to be utilized by the GPS receiver as a target position, and
present the actual position as the suggested target position to be used by the GPS receiver.

20. The wireless electronic device according to claim 19, where the display presents an image in several layers, and one of the layers include the map picture and another one of the layers includes the actual map.

21. The wireless electronic device of claim 20, where the display presents the first position in yet another one of the layers.

22. The wireless electronic device of claim 19, where a user interface incorporates the display for output of visual information from the GPS receiver.

23. The wireless electronic device of claim 19, where the digital camera functions as a video camera capturing serial images and the display is a touch screen that shows the serial images and receives input from a user pointing on at least two different positions on the display, and where the processor identifies the first position as one of the at least two different positions and a second position as a second of the at least two different positions in two corresponding map pictures out of the serial images.

24. The wireless electronic device of claim 23, where the touch screen and the processor create each of the two corresponding map pictures responsive to a user touching the touch screen.
